(19) United States
(12) Patent Application Publication
(10) Pub. No.: US 2026/0304189 A1
(43) Pub. Date: Oct. 1, 2026

(54) MEASUREMENT REPORTING METHOD, APPARATUS, STORAGE MEDIUM, USER EQUIPMENT, AND NETWORK DEVICE

(71) Applicant: Beijing Xiaomi Mobile Software Co., Ltd., Beijing (CN)

(72) Inventor: Xing YANG, Beijing (CN)

(73) Assignee: Beijing Xiaomi Mobile Software Co., Ltd., Beijing (CN)

(21) Appl. No.: 19/478,199

(22) PCT Filed: Apr. 24, 2023
(86) PCT No.: PCT/CN2023/090433

§ 371 Date: Oct. 23, 2025

(51) Int. Cl. H04W 24/10; H04B 7/06

(52) U.S. Cl. CPC H04W 24/10; H04B 7/06952

(57) ABSTRACT

A method for measurement reporting, performed by user equipment, the method including: acquiring a first measurement result, where the first measurement result is a measurement result within a first time period; obtaining a second measurement reslt by performing a measurement result perdiction operation based on the first measurement result, where the second measuremnet result is a measurement result within a second time period; and sending the second measurement result to a network device.

### CROSS-REFERENCE TO RELATED APPLICATION

The present application is a U.S. National Stage of International Application No. PCT/CN2023/090433, filed on Apr. 24, 2023, the contents of all of which are incorporated herein by reference in their entirety for all purposes.

### BACKGROUND OF THE INVENTION

With the application and development of mobile communication technology, when a user uses user equipment (UE), a network device typically issues measurement configuration information to the user equipment. The user equipment can perform measurements according to the content of the measurement configuration information, and report a measurement result to the network device, so that the network device enables, based on the measurement result, the user equipment to reside in a cell with an optimal signal quality.

### SUMMARY OF THE INVENTION

The present disclosure relates to the technical field of communications, and in particular, to a method and device for measurement reporting, a storage medium, user equipment, and a network device.

According to a first aspect of embodiments of the present disclosure, a method for measurement reporting is provided. The method is performed by user equipment and includes:
acquiring a first measurement result, where the first measurement result is a measurement result within a first time period;
obtaining a second measurement result by performing a measurement result prediction operation based on the first measurement result, where the second measurement result is a measurement result within a second time period; and
sending the second measurement result to a network device.

According to a second aspect of the embodiments of the present disclosure, a method for measurement reporting is provided. The method is performed by a network device and includes:
receiving a second measurement result sent by user equipment, where the second measurement result is acquired by performing a measurement result prediction operation on a first measurement result, the first measurement result is a measurement result within a first time period, and the second measurement result is a measurement result within a second time period.

According to a third aspect of the embodiments of the present disclosure, user equipment is provided, including:
an acquisition module configured to acquire a first measurement result, where the first measurement result is a measurement result within a first time period;
a processing module configured to obtain a second measurement result by performing a measurement result prediction operation based on the first measurement result, where the second measurement result is a measurement result within a second time period; and
a sending module configured to send the second measurement result to a network device.

According to a fourth aspect of the embodiments of the present disclosure, a network device is provided, including:
a receiving module configured to receive a second measurement result sent by user equipment, where the second measurement result is acquired by performing a measurement result prediction operation on a first measurement result, the first measurement result is a measurement result within a first time period, and the second measurement result is a measurement result within a second time period.

According to a fifth aspect of the embodiments of the present disclosure, a communication device is provided, including:
one or more first processors; and
a first memory storing executable instructions executable by the one or more first processors,
where the one or more first processors are collectively configured to execute the executable instructions to perform the method for measurement reporting in the first aspect of the present disclosure.

According to a sixth aspect of the embodiments of the present disclosure, a communication device is provided, including:
one or more second processors; and
a second memory storing executable instructions executable by the one or more second processors,
where the one or more second processors are collectively configured to execute the executable instructions to perform the method for measurement reporting in the second aspect of the present disclosure.

According to a seventh aspect of the embodiments of the present disclosure, a communication system is provided, including:
user equipment configured to perform the steps of the method for measurement reporting in the first aspect; and
a network device configured to perform the steps of the method for measurement reporting in the second aspect.

According to an eighth aspect of the embodiments of the present disclosure, a non-transitory computer-readable storage medium is provided. The non-transitory computer-readable storage medium stores computer program instructions, where the computer program instructions, when executed by one or more processors, implement the steps of the methods for measurement reporting in the first aspect and the second aspect of the present disclosure.

### BRIEF DESCRIPTION OF DRAWINGS

The above and/or additional aspects and benefits of the present disclosure will become apparent and readily understood from the following description of embodiments in conjunction with the accompanying drawings.

FIG. 1 is an application scenario of a method for measurement reporting according to some embodiments.

FIG. 2 is a flowchart of a method for measurement reporting according to some embodiments.

FIG. 3 is a flowchart of a method for measurement reporting according to some other embodiments.

FIG. 4 is a flowchart of a method for measurement reporting according to yet other embodiments.

FIG. 5 is a flowchart of a method for measurement reporting according to yet other embodiments.

FIG. 6 is a flowchart of a method for measurement reporting according to yet other embodiments.

FIG. 7 is a flowchart of a method for measurement reporting according to yet other embodiments.

FIG. 8 is a flowchart of a method for measurement reporting according to yet other embodiments.

FIG. 9 is a flowchart of a method for measurement reporting according to some embodiments.

FIG. 10 is a block diagram of user equipment according to some embodiments.

FIG. 11 is a block diagram of a network device according to some embodiments.

FIG. 12 is a block diagram of a communication device according to some embodiments.

FIG. 13 is a block diagram of a communication device according to some embodiments.

### DETAILED DESCRIPTION OF THE INVENTION

Examples will be described in detail herein, and these examples are illustrated in the accompanying drawings. When the following description refers to the accompanying drawings, the same numerical symbols in different accompanying drawings represent the same or similar elements, unless otherwise indicated. The implementations described in the following examples do not represent all implementations consistent with the present disclosure. Instead, they are merely examples of devices and methods consistent with some aspects of the present disclosure as detailed in the appended claims.

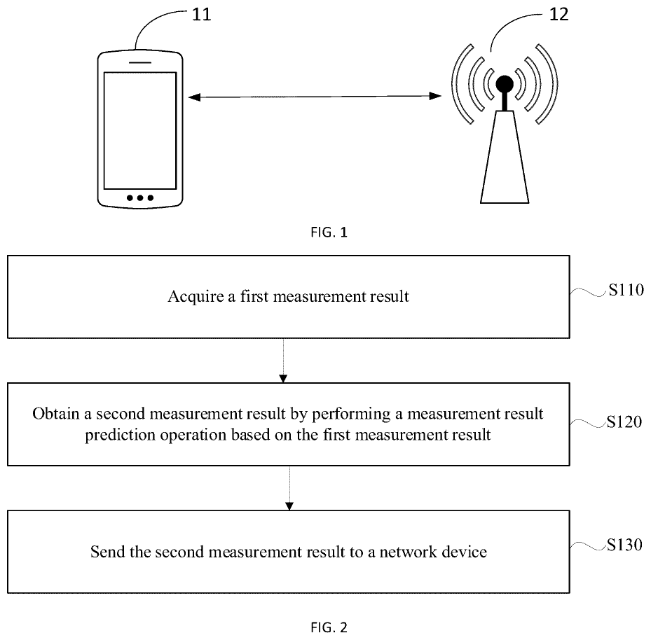

The following describes an application environment of a method for measurement reporting provided in the embodiment of the present disclosure. As shown in FIG. 1, the application scenario includes user equipment 11 and a network device 12. The user equipment 11 may be user equipment (UE) or other terminal-side devices, such as a mobile phone, a tablet personal computer, a laptop computer, a personal digital assistant (PDA), a mobile internet device (MID), a wearable device, a smart vehicle, an in-vehicle device, or a robot. It is to be noted that the type of the terminal is not limited in the present disclosure.

The network device 12 can be configured to provide a communication network and allocate uplink and downlink dynamic resources for the user equipment. The network device 12 may be a base station. A base station is a device deployed in an access network to provide a wireless communication function for a terminal. The base station may be either a base station of a serving cell of the terminal or a base station of a neighbor cell of the serving cell of the terminal. The base station may include various forms of macro base stations, micro base stations, relay stations, access points, transmission reception points (TRPs), etc. In systems employing different wireless access technologies, names of devices with the functions of the base station may vary. In 5G new radio (NR) systems, such devices are called gNodeB or gNB. As communication technologies evolve, the description of the term “base station” may change.

In some implementations, the user equipment (UE) may receive a measurement configuration sent by the network device, and perform measurements based on the measurement configuration. The measurement configuration may include a measurement object, a report configuration, and a quantity configuration. The measurement object may be configured to indicate a frequency that needs to be measured, and may include a plurality of access technologies. For example, the measurement object includes new radio (NR), long term evolution (LTE), etc. Each measurement object may be bound to one measurement object identifier (measObject ID).

In an example, the report configuration may be configured to indicate a type of reporting by the user equipment. The type of reporting by the user equipment may include a periodic reporting configuration and an event-based report configuration. Different report configurations may be configured for measurement objects of different access technologies, and each report configuration may be bound to one report configuration identifier (reportconfig ID).

In an example, the event-based report configuration may include at least one of the following: a type of a signal that triggers reporting, where the type of the signal that triggers reporting may include reference signal receiving power (RSRP), reference signal receiving quality (RSRQ), or signal to interference plus noise ratio (SINR); a threshold or an offset; a type of a reported measurement result, where the type of the reported measurement result may include RSRP, RSRQ, or SINR; or a relationship between signal measurement results for a serving cell or a neighbor cell, or a relationship between the signal measurement result and a threshold, where the relationship is compared by the UE, and the reporting of the measurement result is triggered in a case where a threshold demand is met.

In some implementations, event-based measurement reporting may include A1-A6,B1-B2, D1, T1, etc. A-series events are configured for intra-system mobility management. B-series events are configured for inter-system mobility management. D1 and T1 are configured for satellite system mobility management. For example, A-series reporting events are described as follows:
Event A1: Serving becomes better than absolute threshold;
Event A2: Serving becomes worse than absolute threshold;
Event A3: Neighbor becomes amount of offset better than PCell/PSCell;
Event A4: Neighbor becomes better than absolute threshold;
Event A5: PCell/PSCell becomes worse than absolute threshold1 AND Neighbor/SCell becomes better than another absolute threshold2; and
Event A6: Neighbor becomes amount of offset better than SCell.

In some implementations, in a case where the user equipment performs the measurement reporting, the measurement reporting may include at least one of the following: an identifier of a cell that triggers an event and a measurement result for this cell; or identifiers of N cells with best measurement results and measurement results for the N cells. For each event, an entering condition and a leaving condition are defined. In a case where the entering condition is not met, the user equipment may evaluate the entering condition of this event, and for an event where the entering condition is met, the user equipment may evaluate the leaving condition of this event. Hence, in a case where the entering condition is met or the leaving condition is met, the user equipment may trigger the measurement reporting.

For example, in a case where a condition A3-1 is satisfied/met/fulfilled, it can be considered that the entering condition for this event is fulfilled. In a case where a condition A3-2 is satisfied/met/fulfilled, it can be considered that the leaving condition for this event is fulfilled. For the event A3, the entering condition may be Mn+Ofn+Ocn-Hys>Mp+Ofp+Ocp+Off, and the leaving condition may be Mn+Ofn+Ocn+Hys<Mp+Ofp+Ocp+Off. Mn may be a measurement result for a neighbor cell, and/or may not consider an offset. Ofn may be a measurement object-specific offset of a reference signal in the neighbor cell, such as offsetMO defined within measObjectNR and corresponding to a frequency of the neighbor cell. Ocn may be a cell-specific offset of the neighbor cell, such as cellIndividualOffset defined within the measObjectNR and corresponding to the frequency of the neighbor cell, where Ocn may be set to zero in a case where Ocn is not configured for the neighbor cell. Mp may be a measurement result for at least one of a PCell or a PSCell, and/or may not consider an offset. Ofp may be a measurement object-specific offset of a SpCell, such as offsetFreq defined within the measObjectNR and corresponding to the SpCell. Ocp may be a cell-specific offset of the SpCell, such as the cellIndividualOffset defined within the measObjectNR, and/or Ocp may be set to zero in a case where Ocp is not configured for the SpCell. Hys may be a hysteresis parameter for the event, such as a hysteresis defined for the event within reportConfigNR. Off may be an offset parameter for the event, such as a3-Offset defined for the event within the reportConfigNR. At least one of Mn or Mp may be expressed in dBm for the RSRP, and/or in dB for the RSRQ and the RS-SINR. In addition, at least one of Ofn, Ocn, Ofp, Ocp, Hys, or Off may be expressed in dB.

A machine learning (ML) algorithm is one of the most important implementation methods for an artificial intelligence (AI) technology. The machine learning can obtain a target model through a large amount of training data, a measurement result can be predicted through the target model, and a higher accurate predicted result can be obtained based on the model trained through the machine learning. In an example, the artificial intelligence may be employed in the 5th generation (5G) system for prediction and inference to enhance system performance.

The measurement result acquired by the user equipment typically reflects current and past channel states simply, but cannot reflect a future channel state. Since a future channel quality may change, a wireless link management failure, such as a handover failure, may occur, in a case where the network device performs the wireless link management based on the current measurement result.

FIG. 2 is a flowchart of a method for measurement reporting according to some embodiments. As shown in FIG. 2, the method for measurement reporting may be performed by user equipment and include steps S110 to S130.

In step S110, a first measurement result is acquired.

In some implementations, the measurement result may include a channel quality of a communication link, for example, may include signal quality information of a serving cell and a neighbor cell. The signal quality information may be characterized by any one or more of the following parameters: receiving power of a signal, signal-to-noise ratio of the signal, receiving quality of the signal, or a received signal strength indicator (RSSI) of the signal. The channel quality of the communication link may be characterized by any one or more of the following parameters: reference signal receiving power (RSRP), reference signal receiving quality (RSRQ), signal-to-interference plus noise ratio (SINR), reference signal signal-to-noise and interference ratio (RS-SINR), or a reference signal received signal strength indicator (RS-RSSI).

In the embodiments of the present disclosure, the first measurement result acquired by the user equipment may be a measurement result within a first time period, where the first time period may be a current moment or a time period before the current moment. In addition, the first measurement result may be a measurement result for a cell, or a measurement result for a beam.

In step S120, a second measurement result is obtained by performing a measurement result prediction operation based on the first measurement result.

In an example, after acquiring the first measurement result, the user equipment may obtain the second measurement result by performing the measurement result prediction operation based on the first measurement result. For example, the user equipment may predict the second measurement result based on the first measurement result by using a machine learning.

In an example, the user equipment may input the first measurement result into a measurement result prediction model to output the second measurement result through the measurement result prediction model. The measurement result prediction model is acquired through training with a large number of datasets. The datasets may include measurement result samples at a first moment and measurement result samples at a second moment. The measurement result samples at the first moment may be results measured at the current moment or at a time period before the current moment. The measurement result samples at the second moment may be measurement results at a future moment. It is to be noted that training data in the datasets may be historical measurement results actually measured by the user equipment.

In the embodiments of the present disclosure, the second measurement result may be a measurement result within a second time period, where the second time period may be a time period after the current moment. It can be seen that the second measurement result is a measurement result at a future moment relative to the first measurement result, i.e., a predicted measurement result.

In some implementations, the second measurement result may be a measurement result for a cell, or a measurement result for a beam. In addition, the cells or the beams corresponding to the first measurement result and the second measurement result are the same.

In an example, the first measurement result is a measurement result for a cell, and the second measurement result obtained by performing the measurement result prediction operation based on the first measurement result is a measurement result for the cell. In this case, the cell corresponding to the first measurement result is the same as the cell corresponding to the second measurement result.

In an example, the first measurement result is a measurement result for a beam, and the second measurement result obtained by performing the measurement result prediction operation based on the first measurement result is a measurement result for the beam. In this case, the beam corresponding to the first measurement result is the same as the beam corresponding to the second measurement result.

In an example, the first measurement result is a measurement result for a cell, and the second measurement result obtained by performing the measurement result prediction operation based on the first measurement result is a measurement result for a beam.

In an example, the first measurement result is a measurement result for a beam, and the second measurement result obtained by performing the measurement result prediction operation based on the first measurement result is a measurement result for a cell.

In some other implementations, the measurement type corresponding to the first measurement result and the measurement type corresponding to the second measurement result are the same, where the measurement type may include RSRP, RSRQ, or SINR etc. For example, the measurement type corresponding to the first measurement result is RSRP, and the measurement type corresponding to the second measurement result is also RSRP. For another example, the measurement type corresponding to the first measurement result is SINR, and the measurement type corresponding to the second measurement result is also SINR.

In step S130, the second measurement result is sent to a network device.

In an example, after acquiring the second measurement result, the user equipment may send the second measurement result to the network device. For example, the user equipment may send the second measurement result to the network device through uplink control information (UCI), i.e., the uplink control information may carry the second measurement result.

In an example, the user equipment may send the second measurement result to the network device through medium access control control element (MAC-CE) signaling, i.e., the MAC-CE signaling may carry the second measurement result.

In an example, the user equipment may send the second measurement result to the network device through a configured grant uplink (UL) channel reserved by the network device, i.e., the user equipment may report the second measurement result to the network device using a manner of UL configured grant.

In an example, the user equipment may send the second measurement result to the network device through a contention free random access (CFRA) uplink channel, i.e., the user equipment may report the second measurement result to the network device using a manner of the CFRA.

In an example, the user equipment may send the second measurement result to the network device through a contention-based random access (CBRA) uplink channel, i.e., the user equipment may report the second measurement result to the network device using a manner of the CBRA.

It is to be noted that the second measurement result may be carried in the measurement reporting, i.e., the measurement reporting may carry a measurement result, for a cell or a beam, that meets a measurement reporting demand. In other words, the second measurement result may be sent to the network device through the measurement reporting, in a case where the second measurement result meets the measurement reporting demand. In addition, there may be a plurality of second measurement results predicted by the user equipment. For example, the user equipment can predict all measurement results within the next 5 to 10 seconds.

According to the embodiments of the present disclosure, the user equipment may acquire the first measurement result, where the first measurement result may be the measurement result within the first time period; obtain the second measurement result by performing the measurement result prediction operation based on the first measurement result; and then send the second measurement result to the network device. In this way, a failure caused by a channel change can be avoided, i.e., the success rate of wireless link management can be improved.

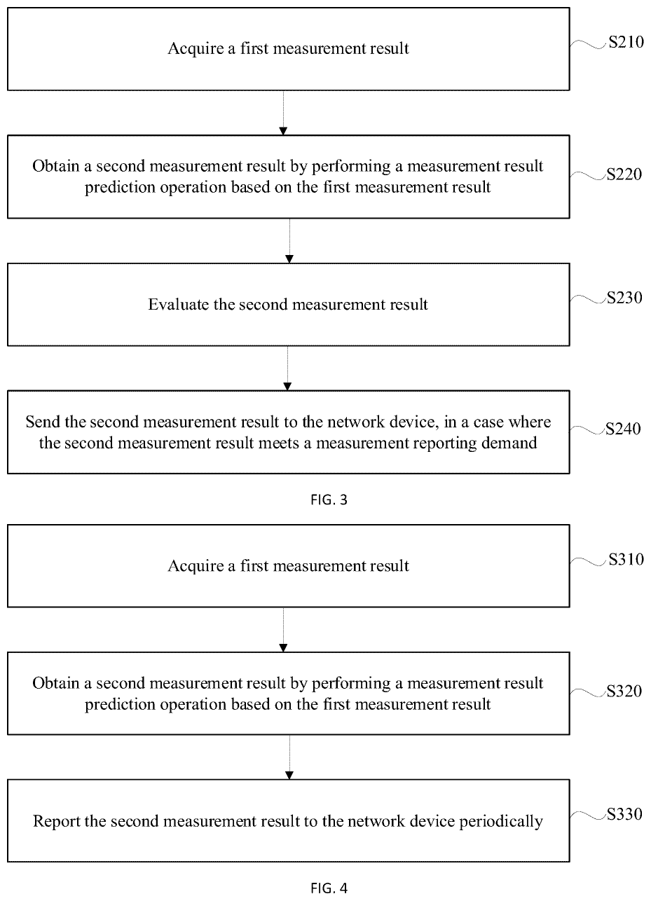

FIG. 3 is a flowchart of a method for measurement reporting according to some other embodiments. As shown in FIG. 3, the method for measurement reporting may be performed by the user equipment and includes steps S210 to S240.

In step S210, a first measurement result is acquired.

In step S220, a second measurement result is obtained by performing a measurement result prediction operation based on the first measurement result.

The implementations of steps S210 and S220 have been described in detail in other embodiments and will not be redundantly elaborated herein.

In step S230, the second measurement result is evaluated.

The first measurement result and the second measurement result may be RSRP, RSRQ, or SINR etc. The measurement type corresponding to the first measurement result and the measurement type corresponding to the second measurement result may be the same.

In some implementations, after acquiring the second measurement result by performing the measurement result prediction operation, the user equipment may evaluate the acquired second measurement result. For example, the user equipment may evaluate the acquired second measurement result using the measurement reporting of the events mentioned in other embodiments, i.e., the user equipment may evaluate the second measurement result using the A-series events, the B-series events, the D1 event, and the T1 event, etc.

In other words, the user equipment may evaluate the second measurement result to determine whether the second measurement result meets the measurement reporting demand. When evaluating the second measurement result, the user equipment triggers the measurement reporting in a case where an event is evaluated to be met. For example, the entering condition of the event is evaluated, in a case where the entering condition of the event is not met; and the leaving condition of the event is evaluated, in a case where the entering condition of the event is met.

In addition, in a case where it is determined that the second measurement result meets the measurement reporting demand, the user equipment may send the second measurement result to the network device, i.e., proceed to step S240.

In step S240, the second measurement result is sent to the network device, in a case where the second measurement result meets the measurement reporting demand.

The first measurement result and the second measurement result may be the measurement results for a cell, or the measurement results for a beam. The second measurement result meeting the measurement reporting demand may include any of the following: the second measurement result for the cell or the beam meets the entering condition or the leaving condition of the event, i.e., the measurement result for the cell or the beam meets the entering condition or the leaving condition of the event; the second measurement result for the cell is a best measurement result among measurement results for a plurality of cells on a first frequency, where the first frequency may be a to-be-measured frequency indicated by the network device, i.e., the measurement result for the cell is the best on the frequency where the cell is located; the second measurement result for the beam is a best measurement result among measurement results for a plurality of beams in a cell where the beam is located, i.e., the measurement result for the beam is the best in the cell where the beam is located; the cell is a measured target cell; or the beam belongs to a measured target cell. It is to be noted that the user equipment may determine the best/optimal measurement result among cells with measurement results.

In an implementation, in a case where the second measurement result is a measurement result for a cell, it is determined that the second measurement result meets the measurement reporting demand and is sent to the network device, in a case where it is determined that the second measurement result for the cell meets an entering condition of an event. In an example, in a case where the second measurement result is a measurement result for a cell, it is determined that the second measurement result meets the measurement reporting demand and is sent to the network device, in a case where it is determined that the second measurement result for the cell meets a leaving condition of an event.

In an example, in a case where the second measurement result is a measurement result for a beam, it is determined that the second measurement result meets the measurement reporting demand and is sent to the network device, in a case where it is determined that the second measurement result for the beam meets an entering condition of an event. In an example, in a case where the second measurement result is a measurement result for a beam, it is determined that the second measurement result meets the measurement reporting demand and is sent to the network device, in a case where it is determined that the second measurement result for the beam meets a leaving condition of an event.

In an example, in a case where the second measurement result is a measurement result for a beam, it is determined that the second measurement result meets the measurement reporting demand and is sent to the network device, in a case where it is determined that the second measurement result for the beam meets an entering condition of the event A3.In an example, in a case where the second measurement result is a measurement result for a beam, it is determined that the second measurement result meets the measurement reporting demand and is sent to the network device, in a case where it is determined that the second measurement result for the beam meets a leaving condition of the event A3.

In the embodiments of the present disclosure, in a case of reporting the second measurement result to the network device, the user equipment may also send to the network device an identifier of an event where the entering condition or the leaving condition is met. For example, it is determined that the second measurement result meets the entering condition of the event A3 during evaluation, and then the user equipment may send the identifier “1” of the event A3 to the network device. The identifier of the event A3 is provided merely as an example and is not intended to impose any practical limitation. In addition, the identifier of the event where the entering condition or the leaving condition is met may be carried in the measurement reporting.

In another implementation, in a case where the second measurement result is a measurement result for a cell, it is determined that the second measurement result meets the measurement reporting demand and is sent to the network device, in a case where it is determined that the second measurement result for the cell is the best measurement result among measurement results for a plurality of cells on a first frequency. The first frequency may be a to-be-measured frequency indicated by the network device.

In another implementation, in a case where the second measurement result is a measurement result for a beam, it is determined that the second measurement result meets the measurement reporting demand and is sent to the network device, in a case where it is determined that the second measurement result for the beam is the best measurement result among measurement results for a plurality of beams in a cell where the beam is located.

In another implementation, in a case where the second measurement result is a measurement result for a cell, it is determined that the second measurement result meets the measurement reporting demand in a case where it is determined that the cell is a measured target cell. That is, it is determined that the second measurement result meets the measurement reporting demand and is sent to the network device, in a case where it is determined that the cell corresponding to the second measurement result is a target cell.

In another implementation, in a case where the second measurement result is a measurement result for a beam, it is determined that the second measurement result meets the measurement reporting demand, in a case where it is determined that the beam belongs to the measured target cell. That is, it is determined that the second measurement result meets the measurement reporting demand and is sent to the network device, in a case where it is determined that the beam corresponding to the second measurement result belongs to the target cell.

It is to be noted that the measurement reporting demand may also include: the beam being a measured target beam. It is determined that the second measurement result meets the measurement reporting demand and is sent to the network device, in a case where at least one of the plurality of measurement reporting demands of the present disclosure meets an evaluation condition. In other words, the plurality of measurement reporting demands of the present disclosure can be used individually or in combination. For example, it is determined that the second measurement result meets the measurement reporting demand, in a case where it is determined that the second measurement result for the cell meets the entering condition of the event and the cell is the measured target cell. For another example, it is determined that the second measurement result meets the measurement reporting demand, in a case where it is determined that the second measurement result for the beam is the best measurement result among the measurement results for the plurality of beams in the cell where the user equipment is located and it is determined that the beam belongs to the measured target cell. The plurality of measurement reporting demands of the present disclosure can be combined according to actual circumstances, and the combinations will not be redundantly elaborated herein.

It is to be noted that the measurement reporting demand in the embodiments of the present disclosure may be referred to as triggering-event reporting, i.e., the measurement reporting demand may be related to an event.

It is also to be noted that a plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may acquire the first measurement result, where the first measurement result may be the measurement result within the first time period; obtain the second measurement result by performing the measurement result prediction operation based on the first measurement result; evaluate the predicted second measurement result; and report the second measurement result to the network device, in a case where it is determined that the second measurement result meets the measurement reporting demand. In this way, the success rate of handover can be improved.

FIG. 4 is a flowchart of a method for measurement reporting according to yet other embodiments. As shown in FIG. 4, the method for measurement reporting may be performed by the user equipment and includes steps S310 to S330.

In step S310, a first measurement result is acquired.

In step S320, a second measurement result is obtained by performing a measurement result prediction operation based on the first measurement result.

The implementations of steps S310 and S320 have been described in detail in other embodiments and will not be redundantly elaborated herein.

In step S330, the second measurement result is periodically reported to the network device.

In some implementations, the user equipment may periodically report the second measurement result to the network device, after obtaining the second measurement result by performing the measurement result prediction operation. During this process, the user equipment may receive periodic information configured by the network device, and periodically report, according to the periodic information, the second measurement result to the network device. For example, the network device sends the periodic information to the user equipment through a radio resource control (RRC) dedicated message or a common message. The user equipment may report the second measurement result every 10 ms, in a case where the network device configures a period of 10 ms.

It is to be noted that the plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may acquire the first measurement result, where the first measurement result may be the measurement result within the first time period; obtain the second measurement result by performing the measurement result prediction operation based on the first measurement result; and report the second measurement result to the network device periodically. In this way, not only the success rate of wireless link management can be improved, but also the real-time reporting of the measurement result can be ensured.

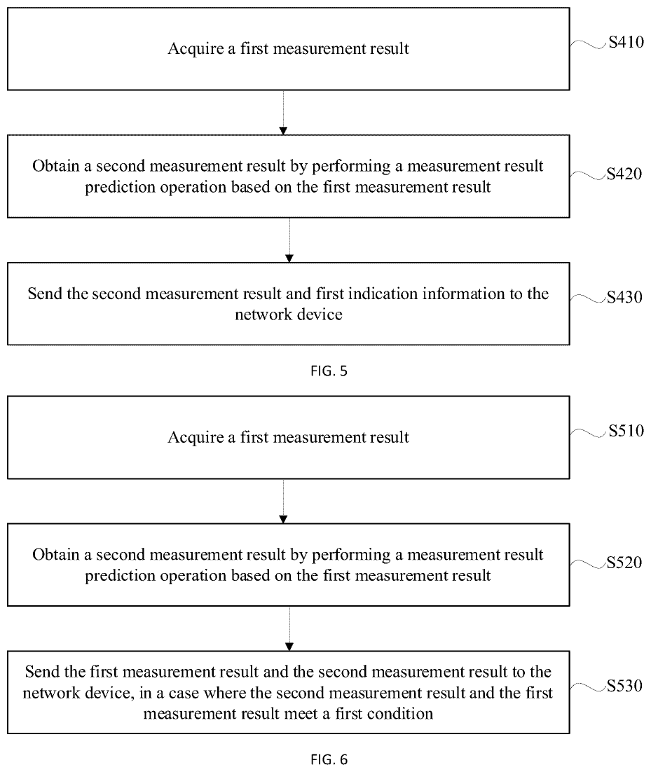

FIG. 5 is a flowchart of a method for measurement reporting according to yet other embodiments. As shown in FIG. 5, the method for measurement reporting may be performed by the user equipment and includes steps S410 to S430.

In step S410, a first measurement result is acquired.

In step S420, a second measurement result is obtained by performing a measurement result prediction operation based on the first measurement result.

The implementations of steps S410 and S420 have been described in detail in other embodiments and will not be redundantly elaborated herein.

In step S430, the second measurement result and first indication information are sent to the network device.

In some implementations, the user equipment may send the second measurement result to the network device, after obtaining the second measurement result by performing the measurement result prediction operation. The reporting of the second measurement result may be triggered when the second measurement result meets an event, i.e., the second measurement result meets the measurement reporting demand. The reporting of the second measurement result may also be triggered periodically. In addition, the user equipment may also send the first indication information to the network device. The first indication information is configured to indicate that the second measurement result is a predicted result, and may also be carried in the measurement reporting.

In some other implementations, the first indication information may include first time information related to the second measurement result. The first time information may include at least one of the following: a time when entering of an event is met; a time when leaving of an event is met; a time when the second measurement result for the cell reaches a maximum value; or a time when the second measurement result for the beam reaches a maximum value. By sending the first time information to the network device, the network device can learn when the event is met, when measurement intensity reaches a maximum value, etc. This further enables more accurate cell handover.

In an implementation, the user equipment may send the time when the entering of the event is met to the network device through the first indication information. It can be learned from the above introduction that there may be a plurality of second measurement results predicted by the user equipment. In other words, the user equipment can predict a plurality of measurement results within a specified future time period, such as predicting all second measurement results within the next 5 to 10 seconds. Among the plurality of predicted second measurement results, there may be one or more second measurement results meeting the entering of the event. The user equipment can send, to the network device through the first indication information, the time corresponding to the second measurement result that meets the entering of the event. This time can be referred to as the time when the entering of the event is met.

In another implementation, the user equipment may send, to the network device through the first indication information, the time when the leaving of the event is met. Among the plurality of predicted second measurement results, there may be one or more second measurement results meeting the leaving of the event. The user equipment can send, to the network device through the first indication information, the time corresponding to the second measurement result that meets the leaving of the event. This time can be referred to as the time when the leaving of the event is met.

In another implementation, the user equipment may send, to the network device through the first indication information, the time when the second measurement result for the cell reaches a maximum value. The user equipment may take the second measurement result with the best measurement intensity among measurement results for a plurality of cells as a target measurement result, and then send the time corresponding to the target measurement result to the network device. This time can be referred to as the time when the second measurement result for the cell reaches a maximum value.

In another implementation, the user equipment may send, to the network device through the first indication information, the time when the second measurement result for the beam reaches a maximum value. One cell may correspond to a plurality of beams. The user equipment may take the second measurement result with the best measurement intensity among measurement results for a plurality of beams as a target measurement result, and then send the time corresponding to the target measurement result to the network device. This time can be referred to as the time when the second measurement result for the beam reaches a maximum value.

It is to be noted that the user equipment may send each piece of time information in the first time information individually to the network device, or may send a plurality of pieces of time information simultaneously to the network device. For example, the time when the entering of the event is met and the time when the leaving of the event is met are simultaneously sent to the network device. For another example, the time when the entering of the event is met, the time when the leaving of the event is met, and the time when the second measurement result for the beam reaches a maximum value are simultaneously sent to the network device. The time information sent by the user equipment to the network device is not explicitly limited herein and may be selected according to actual circumstances.

In the embodiments of the present disclosure, the first time information may be indicated by any of the following ways: at least one of a system frame number (SFN) or a slot number; or an absolute time. For example, the first time information may be indicated by the system frame number, the slot number, or the absolute time.

It is also to be noted that the plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may acquire the first measurement result, where the first measurement result may be the measurement result within the first time period; obtain the second measurement result by performing the measurement result prediction operation based on the first measurement result; and report the second measurement result and the first indication information to the network device, where the first indication information is configured to indicate that the second measurement result is the predicted result. In this way, not only the success rate of wireless link management can be improved, but also the network device can perform more accurate cell handover.

FIG. 6 is a flowchart of a method for measurement reporting according to yet other embodiments. As shown in FIG. 6, the method for measurement reporting may be performed by the user equipment and includes steps S510 to S530.

In step S510, a first measurement result is acquired.

In step S520, a second measurement result is obtained by performing a measurement result prediction operation based on the first measurement result.

The implementations of steps S510 and S520 have been described in detail in other embodiments and will not be redundantly elaborated herein.

In step S530, the first measurement result and the second measurement result are sent to the network device, in a case where the second measurement result and the first measurement result meet a first condition.

In some implementations, the user equipment can determine a relationship between the second measurement result and the first measurement result, after obtaining the second measurement result by performing the measurement result prediction operation. The user equipment can send the first measurement result and the second measurement result to the network device, in a case where it is determined that the first measurement result and the second measurement result meet the first condition.

In the embodiments of the present disclosure, the first condition may include at least one of the following: the second measurement result is better than the first measurement result by a first offset; the second measurement result is worse than the first measurement result by a second offset; the first measurement result meets an entering condition of an event, and the second measurement result meets a leaving condition of the event; or the first measurement result meets a leaving condition of an event, and the second measurement result meets an entering condition of the event.

In an implementation, the user equipment may send the first measurement result and the second measurement result to the network device, in a case where it is determined that the second measurement result is better than the first measurement result by the first offset.

In another embodiment, the user equipment may send the first measurement result and the second measurement result to the network device, in a case where it is determined that the second measurement result is worse than the first measurement result by the second offset.

In another implementation, the user equipment may send the first measurement result and the second measurement result to the network device, in a case where it is determined that the first measurement result meets the entering condition of the event and the second measurement result meets the leaving condition of the event.

In another implementation, the user equipment may send the first measurement result and the second measurement result to the network device, in a case where it is determined that the first measurement result meets the leaving condition of the event and the second measurement result meets the entering condition of the event.

In some implementations, the plurality of first conditions may be used individually or in combination. For example, the user equipment may send the first measurement result and the second measurement result to the network device, in a case where it is determined that the second measurement result is better than the first measurement result by the first offset, the first measurement result meets the leaving condition of the event and the second measurement result meets the entering condition of the event. The combination of the plurality of first conditions is not explicitly limited herein and may be selected according to actual circumstances.

In the embodiments of the present disclosure, the user equipment may send first indication information and second indication information, when sending measurement reporting that carries the first measurement result and the second measurement result to the network device. The first indication information may be configured to indicate that the second measurement result is a predicted result, and the second indication information may be configured to indicate that the first measurement result is a result actually measured by the user equipment.

It is to be noted that the plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may acquire the first measurement result, where the first measurement result may be the measurement result within the first time period; obtain the second measurement result by performing the measurement result prediction operation based on the first measurement result; and send the first measurement result and the second measurement result to the network device, in a case where the first measurement result and the second measurement result meet the first condition. In this way, the success rate of cell handover can be further ensured.

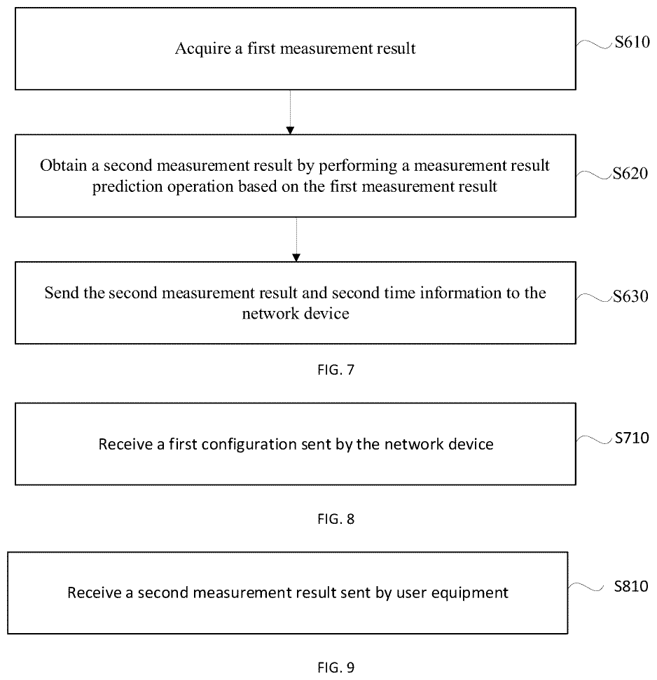

FIG. 7 is a flowchart of a method for measurement reporting according to yet other embodiments. As shown in FIG. 7, the method for measurement reporting may be performed by the user equipment and includes steps S610 to S630.

In step S610, a first measurement result is acquired.

In step S620, a second measurement result is obtained by performing a measurement result prediction operation based on the first measurement result.

The implementations of steps S610 and S620 have been described in detail in other embodiments and will not be redundantly elaborated herein.

In step S630, the second measurement result and second time information are sent to the network device.

In some implementations, the user equipment can send the second measurement result to the network device, after obtaining the second measurement result by performing the measurement result prediction operation. In addition, the user equipment may send the second time information to the network device, where the second time information may be a time when the second measurement result meets a first condition.

The first condition may include at least one of the following: the second measurement result is better than the first measurement result by a first offset; the second measurement result is worse than the first measurement result by a second offset; the first measurement result meets an entering condition of an event, and the second measurement result meets a leaving condition of the event; or the first measurement result meets a leaving condition of an event, and the second measurement result meets an entering condition of the event.

In an implementation, the second time information may be the time when it is determined that the second measurement result is better than the first measurement result by the first offset. That is, the user equipment may acquire the time when the second measurement result is better than the first measurement result by the first offset, and send this time to the network device by carrying this time in a report configuration.

In another implementation, the second time information may be the time when it is determined that the second measurement result is worse than the first measurement result by the second offset. That is, the user equipment may acquire the time when the second measurement result is worse than the first measurement result by the second offset, and send this time to the network device by carrying this time in a report configuration.

In another implementation, the second time information may be the time when the first measurement result meets the entering condition of the event and the second measurement result meets the leaving condition of the event. That is, the user equipment may acquire the time when the first measurement result meets the entering condition of the event and the second measurement result meets the leaving condition of the event, and send this time to the network device by carrying this time in a report configuration.

In another implementation, the second time information may be the time when the first measurement result meets the leaving condition of the event and the second measurement result meets the entering condition of the event. That is, the user equipment may acquire the time when the first measurement result meets the leaving condition of the event and the second measurement result meets the entering condition of the event, and send this time to the network device by carrying this time in a report configuration.

In the embodiments of the present disclosure, the second time information is indicated by any of the following ways: at least one of a system frame number (SFN) or a slot number; or an absolute time. For example, the second time information may be indicated by the system frame number, the slot number, or the absolute time.

It is to be noted that the plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may acquire the first measurement result, where the first measurement result may be the measurement result within the first time period; obtain the second measurement result by performing the measurement result prediction operation based on the first measurement result; and report the second measurement result and the second time information to the network device, where the second time information is the time when the second measurement result meets the first condition. In this way, not only the success rate of wireless link management can be improved, but also the accuracy of cell handover can be further improved.

FIG. 8 is a flowchart of a method for measurement reporting according to yet other embodiments. As shown in FIG. 8, the method for measurement reporting may be performed by the user equipment and includes step S710.

In step S710, a first configuration sent by the network device is received.

In some implementations, the user equipment may receive the first configuration sent by the network device, where the first configuration is configured to indicate whether the user equipment is allowed to acquire the second measurement result. The user equipment may obtain the second measurement result by performing the measurement result prediction operation based on the first measurement result, and send the acquired second measurement result to the network device, in a case where the first configuration instructs the user equipment to acquire the second measurement result. The user equipment may not perform the measurement result prediction operation, in a case where the first configuration instructs the user equipment not to acquire the second measurement result. In an example, the user equipment also does not perform the measurement result prediction operation, in a case where the first configuration is not received by the user equipment.

In the embodiments of the present disclosure, the first configuration may be transmitted based on signaling of a radio resource control protocol, i.e., RRC signaling, or may be a part of an RRC reconfiguration message, or may be transmitted based on signaling of a medium/media access control (MAC) protocol, i.e., MAC signaling. This is not limited herein.

In some implementations, the first configuration may include at least one of a first offset or a second offset, where at least one of the first offset or the second offset are configured to determine the first condition. That is, the user equipment, upon receiving the first configuration, can determine whether the second measurement result is better than the first measurement result by the first offset, or whether the second measurement result is worse than the first measurement result by the second offset.

In some other implementations, the first configuration may further include a prediction time configuration. The prediction time configuration may include at least one of the following: the first time period; the second time period; or a time difference between the first time period and the second time period.

In an example, the user equipment may receive the first time period from the network device through the first configuration, and acquire the first measurement result within the first time period. In an example, the user equipment may receive the second time period from the network device through the first configuration, and acquire the second measurement result within the second time period through prediction based on the first measurement result. In an example, the user equipment may receive the time difference between the first time period and the second time period from the network device through the first configuration, and then acquire the first measurement result and the second measurement result based on this time difference.

It is to be noted that the user equipment may receive one prediction time configuration or a plurality of prediction time configurations from the network device through the first configuration. For example, the user equipment may receive the first time period and the second time period from the network device. For another example, the user equipment may receive the time difference between the first time period and the second time period from the network device. For another example, the user equipment may receive the first time period, the second time period, and the time difference between the first time period and the second time period from the network device. The prediction time configuration included in the first configuration is not explicitly limited herein and may be selected according to actual circumstances.

In addition, the first configuration in the embodiments of the present disclosure may be bound to a measurement object, and different measurement objects can be independently configured. The measurement object is configured to indicate a frequency that needs to be measured, where the frequency that needs to be measured may include different frequencies and frequencies of different access technologies. The network device can instruct the user equipment to predict on a certain frequency.

It is also to be noted that the plurality of embodiments or features separated by “or” do not affect other solutions even if some features are unfeasible. Furthermore, where not contradiction, the embodiments of the present disclosure may be combined with other embodiments or implementations related to the method for measurement reporting and their various optional solutions, in a case of no contradiction. This will not be redundantly elaborated herein.

According to the embodiments of the present disclosure, the user equipment may receive the first configuration sent by the network device, where the first configuration is configured to indicate whether the user equipment is allowed to acquire the second measurement result. The user equipment may predict the second measurement result based on the first measurement result, in a case where the user equipment receives the first configuration and the first configuration indicates that the user equipment is allowed to acquire the second measurement result. In this way, the accuracy of the acquired measurement result can be ensured, and the success rate of cell handover can be further improved.

FIG. 9 is a flowchart of a method for measurement reporting according to some embodiments. As shown in FIG. 9, the method for measurement reporting may be performed by a network device and includes step S810.

In step S810, a second measurement result sent by user equipment is received.

In the embodiments of the present disclosure, the network device may receive the second measurement result sent by the user equipment, where the second measurement result may be acquired by the user equipment through performing a measurement result prediction operation on a first measurement result. The first measurement result may be a measurement result within a first time period, and the second measurement result may be a measurement result within a second time period. In addition, the first time period may be a current moment or a time period before the current moment, and the second time period may be a time period after the current moment.

In some other implementations, the network device may receive first indication information sent by the user equipment, where the first indication information may be configured to indicate that the second measurement result is a predicted result.

In some other implementations, the first indication information may include first time information related to the second measurement result. The first time information may include at least one of the following: a time when entering of an event is met; a time when leaving of an event is met; a time when the second measurement result for the cell reaches a maximum value; or a time when the second measurement result for the beam reaches a maximum value.

In some other implementations, the first time information is indicated by any of the following ways: at least one of a system frame number or a slot number; or an absolute time.

In some other implementations, the network device may receive the first measurement result and the second measurement result that are sent by the user equipment, in a case where the second measurement result and the first measurement result meet a first condition. The first condition includes at least one of the following: the second measurement result is better than the first measurement result by a first offset; the second measurement result is worse than the first measurement result by a second offset; the first measurement result meets an entering condition of an event, and the second measurement result meets a leaving condition of the event; or the first measurement result meets a leaving condition of an event, and the second measurement result meets an entering condition of the event.

In some other implementations, the network device may receive second time information sent by the user equipment, where the second time information is a time when the second measurement result meets the first condition.

In some other implementations, the network device may send a first configuration to the user equipment, where the first configuration is configured to indicate whether the user equipment is allowed to acquire the second measurement result. Whether the user equipment is allowed to acquire the second measurement result may be determined by the network device according to the performance, capabilities, etc. of the user equipment. For example, the network device may allow the user equipment to acquire the second measurement result, in a case where the user equipment has a capability to predict the measurement result. That is, the first configuration sent by the network device to the user equipment indicates that the user equipment is allowed to acquire the second measurement result. In addition, the first configuration may include a first offset and a second offset.

In an example, the first configuration may further include a prediction time configuration. The prediction time configuration may include at least one of the following: the first time period; the second time period; or a time difference between the first time period and the second time period.

It is to be noted that the plurality of embodiments or features separated by “or” do not affect other solutions even if some features are unfeasible. Furthermore, the embodiments of the present disclosure may be combined with other embodiments or implementations related to the method for measurement reporting and their various optional solutions, in a case of no contradiction. This will not be redundantly elaborated herein.

According to the embodiments of the present disclosure, the network device may receive the second measurement result sent by the user equipment. The second measurement result may be acquired by the user equipment through performing the measurement result prediction operation on the first measurement result, where the first measurement result is the measurement result within the first time period, and the second measurement result is the measurement result within the second time period. In this way, the success rate of wireless link management can be improved.

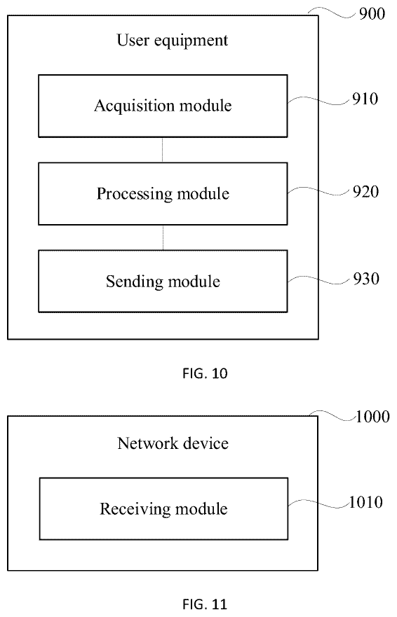

FIG. 10 is a block diagram of user equipment 900 according to some embodiments. Referring to FIG. 10, the user equipment 900 may include an acquisition module 910, a processing module 920, and a sending module 930.

The acquisition module 910 is configured to acquire a first measurement result, where the first measurement result is a measurement result within a first time period.

The processing module 920 is configured to obtain a second measurement result by performing a measurement result prediction operation based on the first measurement result, where the second measurement result is a measurement result within a second time period.

The sending module 930 is configured to send the second measurement result to a network device.

In some implementations, the sending module 930 may include:
an evaluation submodule (not shown) configured to evaluate the second measurement result; and
a sending submodule (not shown) configured to send the second measurement result to the network device, in a case where the second measurement result meets a measurement reporting demand.

In some implementations, the second measurement result is a measurement result for a cell or a measurement result for a beam, and the measurement reporting demand include any of the following:
the second measurement result for the cell or the beam meets an entering condition or a leaving condition of an event;
the second measurement result for the cell is a best measurement result among measurement results for a plurality of cells on a first frequency, where the first frequency is a to-be-measured frequency indicated by the network device;
the second measurement result for the beam is a best measurement result among measurement results for a plurality of beams in a cell where the beam is located;
the cell is a measured target cell; or the beam belongs to a measured target cell.

In some implementations, the sending module 930 is further configured to periodically report the second measurement result to the network device.

In some implementations, the sending module 930 is further configured to send first indication information to the network device, where the first indication information is configured to indicate that the second measurement result is a predicted result.

In some implementations, the first indication information includes first time information related to the second measurement result.

In some implementations, the first time information includes at least one of the following:
a time when entering of an event is met;
a time when leaving of an event is met;
a time when the second measurement result for the cell reaches a maximum value; or
a time when the second measurement result for the beam reaches a maximum value.

In some implementations, the first time information is indicated by any of the following ways:
at least one of a system frame number or a slot number; or
an absolute time.

In some implementations, the sending module 930 is further configured to send the first measurement result and the second measurement result to the network device, in a case where the second measurement result and the first measurement result meet a first condition.

In some implementations, the first condition includes at least one of the following:
the second measurement result is better than the first measurement result by a first offset;
the second measurement result is worse than the first measurement result by a second offset;
the first measurement result meets an entering condition of an event, and the second measurement result meets a leaving condition of the event; or
the first measurement result meets a leaving condition of an event, and the second measurement result meets an entering condition of the event.

In some implementations, the sending module 930 is further configured to send second time information to the network device, where the second time information is a time when the second measurement result meets the first condition.

In some implementations, the user equipment 900 may further include:
a receiving module (not shown) configured to receive a first configuration sent by the network device, where the first configuration is configured to indicate whether the user equipment is allowed to acquire the second measurement result.

In some implementations, the first configuration includes at least one of a first offset or a second offset.

In some implementations, the first configuration further includes a prediction time configuration, and the prediction time configuration includes at least one of the following:
the first time period;
the second time period; or
a time difference between the first time period and the second time period.

According to the embodiments of the present disclosure, the user equipment may acquire the first measurement result, where the first measurement result may be the measurement result within the first time period; obtain the second measurement result by performing the measurement result prediction operation based on the first measurement result; and then send the second measurement result to the network device. In this way, the success rate of wireless link management can be improved.

FIG. 11 is a block diagram of a network device 1000 according to some embodiments. Referring to FIG. 11, the network device 1000 is applied to a network device and may include a receiving module 1010.

The receiving module 1010 may be configured to receive a second measurement result sent by user equipment, where the second measurement result is acquired by performing a measurement result prediction operation on a first measurement result, the first measurement result is a measurement result within a first time period, and the second measurement result is a measurement result within a second time period.

In some implementations, the receiving module 1010 may further be configured to receive first indication information sent by the user equipment, where the first indication information is configured to indicate that the second measurement result is a predicted result.

In some implementations, the first indication information includes first time information related to the second measurement result.

In some implementations, the first time information includes at least one of the following:
a time when entering of an event is met;
a time when leaving of an event is met;
a time when the second measurement result for the cell reaches a maximum value; or
a time when the second measurement result for the beam reaches a maximum value.

In some implementations, the first time information is indicated by any of the following ways:
at least one of a system frame number or a slot number; or
an absolute time.

In some implementations, the receiving module 1010 may further be configured to receive the first measurement result and the second measurement result that are sent by the user equipment, in a case where the second measurement result and the first measurement result meet a first condition.

In some implementations, the first condition includes at least one of the following:
the second measurement result is better than the first measurement result by a first offset;
the second measurement result is worse than the first measurement result by a second offset;
the first measurement result meets an entering condition of an event, and the second measurement result meets a leaving condition of the event; or
the first measurement result meets a leaving condition of an event, and the second measurement result meets an entering condition of the event.

In some implementations, the receiving module 1010 may further be configured to receive second time information sent by the user equipment, where the second time information is a time when the second measurement result meets the first condition.

In some implementations, the network device 1000 may further include:
a receiving module (not shown) configured to send a first configuration to the user equipment, where the first configuration is configured to indicate whether the user equipment is allowed to acquire the second measurement result.

In some implementations, the first configuration includes the first offset and the second offset.

In some implementations, the first configuration further includes a prediction time configuration, and the prediction time configuration includes at least one of the following:
the first time period;
the second time period; or
a time difference between the first time period and the second time period.

According to the embodiments of the present disclosure, the network device may receive the second measurement result sent by the user equipment, where the second measurement result may be acquired by performing the measurement result prediction operation on the first measurement result, the first measurement result is the measurement result within the first time period, and the second measurement result is the measurement result within the second time period. In this way, the success rate of wireless link management can be improved.

Regarding the devices in the embodiments, the manner in which each module performs operations has been described in detail in the related method embodiments and will not be elaborated further herein.

The present disclosure further provides a non-transitory computer-readable storage medium storing computer program instructions, where the computer program instructions, when executed by one or more processors, implement the steps of the method for measurement reporting provided by the present disclosure.

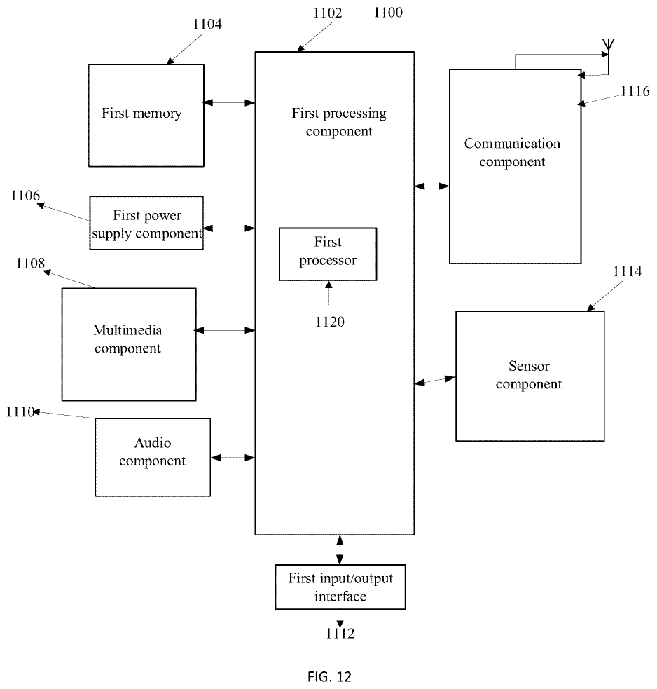

FIG. 12 is a block diagram of a communication device according to some embodiments. For example, the communication device 1100 may be a mobile phone, a computer, a digital broadcasting terminal, a messaging device, a game console, a tablet device, a medical device, a fitness device, a personal digital assistant, a smart car, etc.

Referring to FIG. 12, the communication device 1100 may include one or more of the following components: a first processing component 1102, a first memory 1104, a first power supply component 1106, a multimedia component 1108, an audio component 1110, a first input/output interface 1112, a sensor component 1114, and a communication component 1116.

The first processing component 1102 generally controls the overall operation of the communication device 1100, such as operations associated with display, phone calls, data communication, camera operations, and recording operations. The first processing component 1102 may include one or more first processors 1120 to execute instructions to complete all or part of the steps of the method for measurement reporting. In addition, the first processing component 1102 may include one or more modules to facilitate interaction between the first processing component 1102 and other components. For example, the first processing component 1102 may include a multimedia module to facilitate interaction between the multimedia component 1108 and the first processing component 1102.

The first memory 1104 is configured to store various types of data to support the operation of the communication device 1100. Examples of the data include instructions for any applications or methods operating on the communication device 1100, contact data, phone book data, messages, pictures, videos, etc. The first memory 1104 may be implemented by any type of volatile or non-volatile storage devices or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk, or an optical disk.

The first power supply component 1106 supplies power to various components of the communication device 1100. The first power supply component 1106 may include a power supply management system, one or more power supplies, and other components associated with generating, managing, and distributing power for the communication device 1100.

The multimedia component 1108 includes a screen that provides an output interface between the communication device 1100 and a user. In some embodiments, the screen may include a liquid crystal display (LCD) and a touch panel (TP). The screen, in a case of including the touch panel, may be implemented as a touchscreen to receive an input signal from the user. The touch panel includes one or more touch sensors to sense touches, slides, and gestures on the touch panel. The touch sensor can not only detect a boundary of a touch or slide action, but also detect a duration and pressure associated with the touch or slide operation. In some embodiments, the multimedia component 1108 includes at least one of a front camera or a rear camera. At least one of the front camera or the rear camera can receive external multimedia data, in a case where the communication device 1100 is in an operating mode, such as a shooting mode or a video mode. Each of the front camera and the rear camera may be a fixed optical lens system or may have a focal length and an optical zoom capability.

The audio component 1110 is configured to output and/or input an audio signal. For example, the audio component 1110 includes a microphone (MIC). The microphone is configured to receive an external audio signal, in a case where the communication device 1100 is in an operating mode, such as a call mode, a recording mode, or a voice recognition mode. The received audio signal may be further stored in the first memory 1104 or sent via the communication component 1116. In some embodiments, the audio component 1110 further includes a speaker for outputting the audio signal.

The first input/output interface 1112 provides an interface between the first processing component 1102 and a peripheral interface module. The peripheral interface module may be a keyboard, a click wheel, buttons, etc. These buttons may include, but are not limited to: a home button, volume buttons, a start button, and a lock button.

The sensor component 1114 includes one or more sensors to provide a state assessment for the communication device 1100 in various aspects. For example, the sensor component 1114 may detect an on/off state of the communication device 1100 and a relative positioning of a component. For example, the component is the display and keypad of the communication device 1100. The sensor component 1114 may also detect a change in the position of the communication device 1100 or a component of the communication device 1100, the presence or absence of a contact between the user and the communication device 1100, the orientation or acceleration/deceleration of the communication device 1100, and a temperature change of the communication device 1100. The sensor component 1114 may include a proximity sensor configured to detect the presence of a nearby object without any physical contact. The sensor component 1114 may also include a light sensor, such as a complementary metal-oxide-semiconductor (CMOS) or charge coupled device (CCD) image sensor, for use in imaging applications. In some embodiments, the sensor component 1114 may also include an acceleration sensor, a gyroscope sensor, a magnetic sensor, a pressure sensor, or a temperature sensor.

The communication component 1116 is configured to facilitate communication between the communication device 1100 and other devices in a wired or wireless manner. The communication device 1100 may access a wireless network based on a communication standard, such as Wi-Fi, 2G, 3G, or a combination of them. In an example, the communication component 1116 receives a broadcast signal or broadcast-related information from an external broadcast management system via a broadcast channel. In an example, the communication component 1116 also includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the communication device 1100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the method for measurement reporting.

In an example, a non-transitory computer-readable storage medium including instructions is further provided, such as the first memory 1104 including instructions. The instructions may be executed by the first processor 1120 of the communication device 1100 to implement the method for measurement reporting. For example, the non-transitory computer-readable storage medium may be an ROM, a random access memory (RAM), a compact disc read-only memory (CD-ROM), a magnetic tape, a floppy disk, an optical data storage device, etc.

The device of the disclosure may be an independent electronic device or a part of an independent electronic device. For example, in an embodiment, the device may be an integrated circuit (IC) or a chip, where the integrated circuit may be a single IC or a collection of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SoC), etc. The integrated circuit or chip may be configured to execute executable instructions (or codes) to implement the method for measurement reporting. The executable instructions may be stored within the integrated circuit or chip, or acquired from other devices or equipment. For example, the integrated circuit or chip includes a processor, a memory, and an interface for communication with other devices. The executable instructions may be stored in the memory, and when executed by the processor, implement the method for measurement reporting. Alternatively, the integrated circuit or chip may receive executable instructions via the interface and transmit them to the processor for execution to implement the method for measurement reporting.

In another example, a communication system (not shown) is further provided. The communication system may include user equipment and a network device. The user equipment is configured to perform the steps related to the user equipment of the present disclosure, and the network device is configured to perform the steps related to the network device of the present disclosure.

In another example, a computer program product is also provided. The computer program product includes a computer program executable by a programmable device, where the computer program has a code part, when executed by the programmable device, implementing the method for measurement reporting.

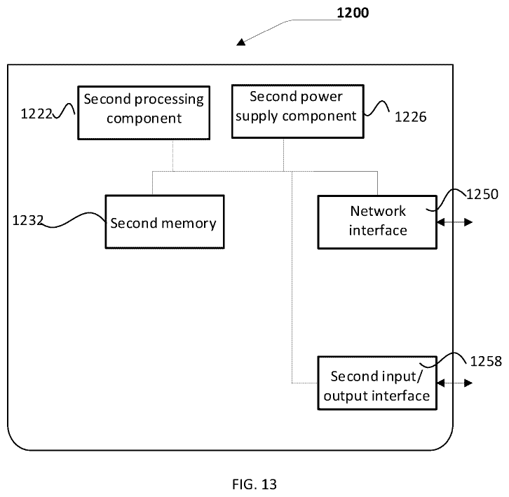

FIG. 13 is a block diagram of a communication device according to an example. For example, the communication device 1200 may be provided as a server. Referring to FIG. 13, the communication device 1200 includes a second processing component 1222, which further includes one or more processors; and a memory resource represented by a second memory 1232 for storing instructions executable by the second processing component 1222, such as an application. The application stored in the second memory 1232 may include one or more modules, and each module corresponds to a set of instructions. In addition, the second processing component 1222 is configured to execute instructions to implement the method for measurement reporting.

The communication device 1200 may also include a second power supply component 1226 configured to perform power supply management for the communication device 1200, a wired or wireless network interface 1250 configured to connect the communication device 1200 to a network, and a second input/output interface 1258. The communication device 1200 may operate based on an operating system stored in the memory 1232, such as Windows Server™, Mac OS XTM, Unix™, Linux™, FreeBSD™, or similar.

As used herein, the term “processor” may refer to one processor that performs the defined functions or a plurality of processors that collectively perform defined functions, such that the execution of the individual defined functions may be divided amongst such processors.

Those skilled in the art will readily think of other embodiments of the present disclosure after considering the specification and practicing the present disclosure. The present disclosure is intended to cover any modifications, uses, or adaptations of the present disclosure. These modifications, uses, or adaptations follow the general principles of the present disclosure and include common knowledge or conventional techniques in the technical field that are not disclosed in the present disclosure. The specification and the embodiments are considered as illustrative merely, and the true scope and spirit of the present disclosure are indicated by the following claims.

It is to be understood that the present disclosure is not limited to the precise structure already described above and shown in the accompanying drawings, and various modifications and changes may be made without departing from the scope of the present disclosure. The scope of the present disclosure is limited merely by the appended claims.

1. A method for measurement reporting, performed by user equipment, the method comprising:
acquiring a first measurement result, wherein the first measurement result is a measurement result within a first time period;
obtaining a second measurement result by performing a measurement result prediction operation based on the first measurement result, wherein the second measurement result is a measurement result within a second time period; and
sending the second measurement result to a network device.

2. The method according to claim 1, wherein sending the second measurement result to the network device comprises:
evaluating the second measurement result; and
sending the second measurement result to the network device, in a case where the second measurement result meets a measurement reporting demand.

3. The method according to claim 2, wherein the second measurement result is a measurement result for a cell or a measurement result for a beam, and the measurement reporting demand comprises any of the following:
the second measurement result for the cell or the beam meets an entering condition or a leaving condition of an event;
the second measurement result for the cell is a best measurement result among measurement results for a plurality of cells on a first frequency, wherein the first frequency is a frequency indicated by the network device;
the second measurement result for the beam is a best measurement result among measurement results for a plurality of beams in a cell where the beam is located;
the cell is a measured target cell; or
the beam belongs to a measured target cell.

4. (canceled)

5. The method according to claim 1, further comprising:
sending first indication information to the network device, wherein the first indication information is configured to indicate that the second measurement result is a predicted result.

6. The method according to claim 5, wherein the first indication information comprises first time information related to the second measurement result.

7. The method according to claim 6, wherein the first time information comprises at least one of the following:
a time when entering of an event is met;
a time when leaving of an event is met;
a time when the second measurement result for a cell reaches a maximum value; or
a time when the second measurement result for a beam reaches a maximum value; or
wherein the first time information is indicated by any of the following ways: at least one of a system frame number or a slot number; or an absolute time.

8. (canceled)

9. The method according to claim 1, further comprising:
sending the first measurement result and the second measurement result to the network device, in a case where the second measurement result and the first measurement result meet a first condition;
wherein the first condition comprises at least one of the following:
the second measurement result is better than the first measurement result by a first offset;
the second measurement result is worse than the first measurement result by a second offset;
the first measurement result meets an entering condition of an event, and the second measurement result meets a leaving condition of the event; or
the first measurement result meets a leaving condition of an event, and the second measurement result meets an entering condition of the event.

10. (canceled)

11. The method according to claim 9, further comprising:
sending second time information to the network device, wherein the second time information is a time when the second measurement result meets the first condition.

12. The method according to claim 1, further comprising:
receiving a first configuration sent by the network device, wherein the first configuration is configured to indicate whether the user equipment is allowed to acquire the second measurement result.

13. The method according to claim 12, wherein the first configuration comprises at least one of a first offset, a second offset, or a prediction time configuration;
wherein the prediction time configuration comprises at least one of the following:
the first time period;
the second time period; or
a time difference between the first time period and the second time period.

14. (canceled)

15. A method for measurement reporting, performed by a network device, the method comprising:
receiving a second measurement result sent by user equipment, wherein the second measurement result is acquired by performing a measurement result prediction operation on a first measurement result, the first measurement result is a measurement result within a first time period, and the second measurement result is a measurement result within a second time period.

16. The method according to claim 15, further comprising:
receiving first indication information sent by the user equipment, wherein the first indication information is configured to indicate that the second measurement result is a

17. The method according to claim 16, wherein the first indication information comprises first time information related to the second measurement result.

18. The method according to claim 17, wherein the first time information comprises at least one of the following:
a time when entering of an event is met;
a time when leaving of an event is met;
a time when the second measurement result for a cell reaches a maximum value; or
a time when the second measurement result for a beam reaches a maximum value-; or
wherein the first time information is indicated by any of the following ways: at least one of a system frame number or a slot number; or an absolute time.

19. (canceled)

20. The method according to claim 15, further comprising:
receiving the first measurement result and the second measurement result sent by the user equipment, in a case where the second measurement result and the first measurement result meet a first condition;
wherein the first condition comprises at least one of the following:
the second measurement result is better than the first measurement result by a first offset;
the second measurement result is worse than the first measurement result by a second offset;
the first measurement result meets an entering condition of an event, and the second measurement result meets a leaving condition of the event; or
the first measurement result meets a leaving condition of an event, and the second measurement result meets an entering condition of the event.

21. (canceled)

22. The method according to claim 20, further comprising:
receiving second time information sent by the user equipment, wherein the second time information is a time when the second measurement result meets the first condition.

23. The method according to claim 15, further comprising:
sending a first configuration to the user equipment, wherein the first configuration is configured to indicate whether the user equipment is allowed to acquire the second measurement result.

24. The method according to claim 23, wherein the first configuration comprises at least one of a first offset, a second offset, or a prediction time configuration;
wherein the prediction time configuration comprises at least one of the following:
the first time period;
the second time period; or
a time difference between the first time period and the second time period.

25.-27. (canceled)

28. A user equipment, comprising:
one or more first processors; and
a first memory storing executable instructions executable by the one or more first processors,
wherein the one or more first processors, when collectively executing the executable instructions, cause the user equipment to:
acquire a first measurement result, wherein the first measurement result is a measurement result within a first time period;
obtain a second measurement result by performing a measurement result prediction operation based on the first measurement result, wherein the second measurement result is a measurement result within a second time period; and
send the second measurement result to a network device.

29. A network device, comprising:
one or more second processors; and
a second memory storing executable instructions executable by the one or more second processors,
wherein the one or more second processors, when collectively executing the executable instructions, cause the network device to perform the method in claim 15.

30.-31. (canceled)
